(19) United States
(12) Patent Application Publication
(10) Pub. No.: US 2021/0142706 A1
(43) Pub. Date: May 13, 2021

(54) MOBILE DEVICE WITH TRANSPARENT DISPLAY AND SCANNER

(71) Applicant: HEWLETT-PACKARD DEVELOPMENT COMPANY, L.P., Houston, TX (US)

(72) Inventors: Dimitre MEHANDJIYSKY, Houston, TX (US); Zheng CAO, LaPuente, CA (US); Kevin L MASSARO, Houston, TX (US); Maria Natalia RUSSI-VIGOYA, Houston, TX (US); Christine HARPER, Houston, TX (US)

(73) Assignee: HEWLETT-PACKARD DEVELOPMENT COMPANY, L.P., Houston, TX (US)

(21) Appl. No.: 16/074,183

(22) PCT Filed: Sep. 30, 2016
(86) PCT No.: PCT/US2016/054824

§ 371 Date: Jul. 31, 2018

(51) Int. Cl. G09G 3/00; G06F 1/16

(52) U.S. Cl. CPC G09G 3/035; G06F 1/1652; G06F 3/0412; G09G 2354/00; G09G 2380/02

(57) ABSTRACT

An example mobile system is disclosed. The system comprises a transparent display screen, and a scanner head to scan an area seen through the transparent display. Position of the scanner is adjustable with respect to the transparent display. The scanner comprises at least one camera and at least one light source. The mobile system further comprises an outer frame, a cover to house the scanner head along with electronic components. The scanner head glides within the outer frame when scanning the area

### BACKGROUND

A most typical method of digitizing and utilizing a paper document is to scan the paper document with a scanner which is an external device connected to a user device (e.g., computer, laptop, tablet) with a cable and to utilize (edit, manipulate, search, and the like) the scanned image rendered on a monitor.

### BRIEF DESCRIPTION OF THE DRAWINGS

Examples are described in the following detailed description and in reference to the drawings, in which:

FIG. 1 illustrates a schematic representation of an example device in accordance with an implementation of the present disclosure;

FIG. 2 illustrates an example device in accordance with an implementation;

FIGS. 3A and 3B illustrate example devices with a charger base in accordance with an implementation;

FIG. 4 illustrates an example system for scanning in accordance with an implementation; and

FIG. 5 illustrates an example process flow diagram in accordance with an implementation.

### DETAILED DESCRIPTION

Various aspects of the present disclosure are directed to a mobile device with a transparent display and a scanner. More specifically, and as described in greater detail below, various aspects of the present disclosure are directed to a manner by which a mobile device can be used in a transparent display mode to scan documents or identified sections within documents.

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device, that connection may be through a direct electrical or mechanical connection, through an indirect electrical or mechanical connection via other devices and connections, through an optical electrical connection, or through a wireless electrical connection. As used herein the term “approximately” means plus or minus 10%. In addition, as used herein, the phrase “user input device” refers to any suitable device for providing an input, by a user, into an electrical system such as, for example, a mouse, keyboard, a hand (or any finger thereof), a stylus, a pointing device, etc.

The following discussion is directed to various examples of the disclosure. Although one or more of these examples may be preferred, the examples disclosed should not be interpreted, or otherwise used, as limiting the scope of the disclosure, including the claims. In addition, one skilled in the art will understand that the following description has broad application, and the discussion of any example is meant only to be descriptive of that example, and not intended to intimate that the scope of the disclosure, including the claims, is limited to that example.

Aspects of the present disclosure described herein disclose allowing the user to scan content by placing the device over text (e.g., in a book, document, website). Among other things, this approach allows interaction with content through one screen by scanning the text and manipulating the scanned text as needed (e.g., search, share). The user can use touch gestures to control the device on the same display. Moreover, aspects of the present disclosure described herein allow utilizing a mobile device with a transparent OLED display which can become opaque as needed and an integrated scanner. The device may be stationed on a base, which can be a stand and a charger for the device in a public setting such as a library, school or office. Among other things, this approach may provide the flexibility of using a single device by a plurality of users.

In one example in accordance with the present disclosure, a method for managing a plurality of instances on a display screen of a display unit is provided. The method comprises receiving, by a processor, a selection of an area of a surface, the surface comprising text, instructing, by the processor, a scanner to scan the text in the selected area of the surface, and overlaying, by the processor, data on the text over the selected area.

In another example in accordance with the present disclosure, a mobile system is provided. The system comprises a transparent display screen, and a scanner head to scan an area seen through the transparent display. Position of the scanner is adjustable with respect to the transparent display. The scanner comprises at least one camera and at least one light source. The mobile system further comprises an outer frame, a cover to house the scanner head along with electronic components. The scanner head glides within the outer frame when scanning the area.

In a further example in accordance with the present disclosure, a non-transitory computer readable medium is provided. The non-transitory computer-readable medium comprises instructions which, when executed, cause a mobile device with a transparent display and a scanner to (i) receive a selection of an area of a surface, the surface comprising text, (ii) instruct the scanner to scan the text in the selected area of the surface, and (iii) overlay data over the selected area on the transparent display.

FIG. 1 is a schematic representation of an example device 100. In the present example, the device 100 is a tablet. In other examples, the device 100 may be a mobile terminal, and may be implemented in various other forms, such as a smartphone, portable laptop computer, etc. It should be readily apparent that the present illustration should not be interpreted to be limited by this particular illustrative architecture shown in FIG. 1, and the display unit 100 represents a generalized illustration and that other elements may be added or the illustrated elements may be removed, modified, or rearranged in many ways.

The device 100 includes a processor 110 (e.g., a central processing unit, a microprocessor, a microcontroller, or another suitable programmable device), a display screen 120, a memory unit 130, input interfaces 140, a communication interface 150, and a scanner 160. Each of these components or any additional components of the display unit 100 is operatively coupled to a bus 105. The bus 105 may be any of several types of bus structures including a memory bus or memory controller, a peripheral bus, and a local bus using any of a variety of bus architectures. In other examples, the display unit 100 includes additional, fewer, or different components for carrying out similar functionality described herein.

The processor 110 includes a control unit 115 and may be implemented using any suitable type of processing system where at least one processor executes computer-readable instructions stored in the memory 130. The processor 110 may be, for example, a central processing unit (CPU), a semiconductor-based microprocessor, an application specific integrated circuit (ASIC), a field-programmable gate array (FPGA) configured to retrieve and execute instructions, other electronic circuitry suitable for the retrieval and execution instructions stored on a computer readable storage medium (e.g., the memory 130), or a combination thereof. The machine readable medium 130 may be a non-transitory computer-readable medium that stores machine readable instructions, codes, data, and/or other information. The instructions, when executed by processor 110 (e.g., via one processing element or multiple processing elements of the processor) can cause processor 110 to perform processes described herein.

Further, the computer readable medium 130 may participate in providing instructions to the processor 110 for execution. The machine readable medium 130 may be one or more of a non-volatile memory, a volatile memory, and/or one or more storage devices. Examples of non-volatile memory include, but are not limited to, electronically erasable programmable read only memory (EEPROM) and read only memory (ROM). Examples of volatile memory include, but are not limited to, static random access memory (SRAM) and dynamic random access memory (DRAM). Examples of storage devices include, but are not limited to, hard disk drives, compact disc drives, digital versatile disc drives, optical devices, and flash memory devices. As discussed in more detail above, the processor 110 may be in data communication with the machine readable medium 130, which may include a combination of temporary and/or permanent storage. The machine readable medium 130 may include program memory that includes all programs and software such as an operating system, user detection software component, and any other application software programs. The machine readable medium 130 may also include data memory that may include multicast group information, various table settings, and any other data required by any element of the ASIC.

The communication interface 150 enables the device 100 to communicate with a plurality of networks and communication links. In some examples, the communication interface of the device 100 may include a Wi-Fi® interface, a Bluetooth interface, a 3G interface, a 4G interface, a near filed communication (NFC) Interface, and/or any other suitable interface that allows the computing device to communicate via one or more networks. The networks may include any suitable type or configuration of network to allow the device 100 to communicate with any external systems or devices.

The display screen 120 may be a transparent an organic light emitting diode (OLED) display, or any other suitable display. More specifically, the display screen 120 is transparent, and thus makes the rear background of the display screen be seen through. The display screen 120 may be a flexible display that can be wrapped and unwrapped from around a bar. An attachment section of the display screen 120 facilitates a coupling of flexible display to the bar in any conventional manner. In one implementation, the flexible display may have a magnetic disclosure, and the display wrapped around the bar may be held in place with the magnetic disclosure. Alternatively, a band may be used to hold the wrapped display around the bar. In various implementations, the flexible display screen 120 may have a variety of structural configuration and material composition. The display screen 120 is to display content from one or more applications communicated to the device 100. In one implementation, the display screen 120 comprises various display properties such as resolution, display pixel density, display orientation and/or display aspect ratio. The display screen 120 may be of different sizes and may support various types of display resolution, where display resolution is the number of distinct pixels in each dimension that can be displayed on the display screen 120. For example, the display screen 120 may support high display resolutions of 1920×1080, or any other suitable display resolutions. When the display screen supports a 1920×1080 display resolution, 1920 is the total number of pixels across the height of the display 120 and 1080 is the total number of pixels across the height of the display 120.

The scanner 160 comprises a plurality of color cameras 170 which is arranged to take an image of an object and/or document. The scanner 160 may include a support of which one end includes the camera 170 and another end is connected to a hinge provided on one point of an outer area of the device 100 and which has a predetermined length, and a hinge to be provided at the other end of the support to enable the support to move. The scanner 160 may further include at least one light source (e.g., LED) 180 and a lighting unit such as various kinds of lenses which provides an exterior light to a transparent display. The scanner 160 may be such that the camera 170 can be positioned to be in the front side or in the rear side of the transparent display 120, i.e., in the front side or in the rear side with respect to the device 100. In one implementation, the scanner 160 moves along a surface and scans the content present on the surface. For example, the scanner 160 may move along a document and scan text and images present on the document. In another implementation, a user of the device 100 may highlight a section of a document, and the scanner 160 may scan only that section. Moreover, the LEDs 180 may be on or blinking when the scanner 160 is actively scanning a surface. Further, the LEDs 180 may be off when the scanner 160 is not active. In another implementation, the scanner 160 may be a 3D image camera. As shown in FIG. 1, the scanner 160 may be implemented in the device 100. In one implementation, the scanner 160 captures an image of the object and/or document in the field of view. In another implementation, the scanner 160 scans the surrounding in 360 panorama to provide up to a 360° field of view. More specifically, a full panoramic view may be provided with electronic panning and point and click zoom to allow an almost instantaneous movement between widely spaced points of interest. Furthermore, the scanner 160 may comprise longer-range, narrow field of view optics to zoom in on specific areas of interest. The scanner 160 may also be implemented, for example, as a binocular-type vision system, such as a portable handheld or head/helmet mounted device to provide a panoramic wide field of view. In another implementation, the scanner 160 may be operable during day and night conditions by utilizing technologies including thermal imagers. In some other implementation, the scanner 160 may comprise a plurality of cameras.

In one implementation, the camera 160 may communicate the identification of the document to the processor 110 to initiate deriving computer readable text from the images of text via optical character recognition (OCR). The images are displayed on the display screen 120. The text may comprise an e-mail, web-site, book, magazine, newspaper, advertisement, another display screen, or other. Moreover, the device 100 uses augmented reality technology. For example, a layer of computer readable text may be displayed on top of, or overlaid, the original image on the display screen 120. As the device 100 or the text on the document or object in view of the camera 160 moves, the display 120 is automatically updated to show the text currently being viewed by the camera 160. Accordingly, the computer readable text is also updated to correspond to the same currently imaged text. It should be noted while a camera is discussed in this specific implementation, other types of scanners may be incorporated in the device 100.

In one implementation, the device 100 may comprise an audio unit. In one implementation, the audio unit comprises an ambisonic sound system, providing three-dimensional (3D) sound in the environment. More specifically, the audio unit sends a sound signal with spatial information that enables the user to perceive the sound as originating from distinct spatial locations and different directions. In one example, the audio unit may target one user. That is, the audio unit may provide an effect of stereo sound when a single user is positioned within the direction of the speaker. In another example, the audio unit may provide a 3D sound for multiple users regardless of the users' positions.

As discussed above, the device 100 may be connected to other devices via VGA, HDMI, USB, Wi-Fi, Bluetooth, NFC over the local network or over the internet cloud. The other devices may be computing device, which includes one of various computing devices that have a keyboard/battery portion and a display screen portion. The computing devices may include, but not limited, to any one of various desktops, laptops, tablets, smart phones, watches and other similar devices. These devices may operate as a stationary computing device (e.g., personal computers (i.e., desktops), server computers, laptop computers (with permanently attached display screens), all in one devices, and other similar devices that possess comparable characteristics). In other implementations, these devices can be handheld devices, such as tablets and smart phones.

In other implementation, there may be additional components that are not shown in FIG. 1. For example, the device 100 illustrated in FIG. 1 includes various engines to implement the functionalities described herein. The device 100 may have an operation engine, which handles an operating system, such as iOS®, Windows®, Android, and any other suitable operating system. The operating system can be multi-user, multiprocessing, multitasking, multithreading, and real-time. In one implementation, the operating system is stored in a memory (e.g., the memory 130 as shown in FIG. 1) performs various tasks related to the use and operation of the device 100. Such task may include installation and coordination of the various hardware components of the device 100, recognizing input from users, such as touch on the display screen, keeping track of files and directories on memory (e.g., the memory 130 as shown in FIG. 1); and managing traffic on bus (e.g., as shown in FIG. 1).

Moreover, in another implementation, the device 100 may comprise a connection engine, which includes various components for establishing and maintaining device connections, such as computer-readable instructions for implementing communication protocols including TCP/IP. HTTP, Ethernet®, USB®, and FireWire®. The application engine may manage the operation of the instances that are displayed on the display unit. For example, the operation engine receives a command from the user to perform an action on one of the instances being displayed on the display unit. The user communicates the command by touching the instance window on the display screen of the display unit. For example, the display unit may display an image of the text that the camera of the device captures, and the user selects (e.g., moving tip of a finger) a section of the image containing a portion of the text that the camera of the device captures. The operation engine communicates the command (e.g., selection of a section of the image) received from the user to the device, and the device may visually indicate the selection of that section. For example, in one example, the device may highlight the selected section. In another implementation, the device may circle or magnify the selected section. An updated instance may be shown on the display screen, available for the user to further operate or manipulate.

FIG. 2 illustrates a device 200, according to an example. The device 200 is shown to be a mobile device, specifically a tablet device. In other examples, the device 200 may in a different form factor, such as a smartphone or a 2-in-1 laptop computer. The device 200 comprises a transparent OLED touchscreen display 220. The transparent OLED touchscreen display may be opaque when the scanner head is not active, and the device 200 acts as a computing device. The device 200 further comprises an outer structural frame 260, a scanner head 230 that glides within the outer structural frame. In one implementation, the scanner head comprises a plurality of cameras 240 and light sources 250, such as LEDs. Further, the device 200 comprises a transparent window 270 at the bottom of the device 200, and a system cover or handle 210 which houses the scanning head 230. More specifically, the scanner head 230 is retracted into the system cover 210 when the device 200 is not actively scanning a surface. Further, the system cover 210 also houses all the computing device electronics, such as a processor, memory, speaker, headphone jack, magnets, battery (or any other power source), any connector components (e.g., USB-C) (not shown in FIG. 2).

FIGS. 3A and 38 illustrate devices 310-340, according to an example. As illustrated in the Figs., the devices 310-340 may be connected to bases 350-380 respectively. More specifically, the device 310 docks into base 350; the device 320 docks into the base 360; the device 330 docks into the base 370, and the device 340 docks into the base 380. The bases 350-380 act as docking stations for the devices 310-340. More specifically, the devices 310-340 may be stored on the bases 350-380 while not being used. Moreover, the devices 310-340 may be charged by the bases 350-380 while docked in. This is enabled by a magnetic strip on the bases 350-380. An example magnetic strip 325 is illustrated in FIG. 3A. More specifically, the magnetic strip comprises multiple charging coils for wireless charging of the device 310. The magnetic polarity is designed in such a way that the device 310 docks into the base properly and is connected to the charging coils. The base initiates the charging when the device is docked into the base. Further, the base activates NFC connectivity, turns the device off or puts the device on sleep mode when the device is docked back, triggers automatic software updates and reinstallations as needed. In one implementation, the base 350-380 may be connected to a database which contains information about user profiles. In such implementation, if a user approaches to the devices 310-340, and decides to interact with one of the devices, the device may identify the user and log the user into its system.

In one implementation, a base may be a stand-alone component. As shown in FIG. 3A, the base 350 is a single stand-alone component. In another implementation, a base may be a modular component. More specifically, a base may be attached to at least one other base. For example, FIG. 3B illustrates a plurality of bases (e.g., the bases 360-380) as attached to one another. In such example, the bases 360-380 may share power and the devices 330-350 may be charged via a single power source. Each of the bases may be any suitable combination of hardware and programming to implement the functionalities of the respective base. Such combinations of hardware and programming may be implemented in a number of different ways. For example, the programming for the bases may be processor executable instructions stored on a non-transitory machine-readable storage medium and the hardware for the bases may include a processing resource to execute those instructions. In such examples, the machine-readable storage medium may store instructions. The machine-readable storage medium storing the instructions may be integrated in a computing device including the processing resource to execute the instructions, or the machine-readable storage medium may be separate but accessible to the device and the processing resource. The processing resource may comprise one processor or multiple processors included in a single computing device or distributed across multiple computing devices. Although various bases are shown in FIG. 3B, in other implementations, the functionality of the bases 360-380 may be implemented as a single component. More specifically, the bases 360-380 may be connected permanently, and may be in a single component form (e.g. a tray looking base component).

FIG. 4 illustrates an example device 400 with a document 410 in the field view of the device 400. Similar to devices in FIGS. 1, 2, 3A and 3B, the device 400 comprises a transparent display screen 420 and a scanner head 430. In the present example, the document 410 is displayed on the screen 420. A user of the device 400 selects a portion 425 of the document 410. In one implementation, the selected portion 425 may be highlighted. In another implementation (as shown in FIG. 4), the selection portion 425 may be captured in a box. Further, the scanner head 430 of the device 400 moves along the selection portion 425 to scan the content. As described in reference to FIGS. 1, 2, 3A and 3B, a plurality of cameras and light sources (e.g., LEDs) may be utilized during the scanning process.

In one implementation, a content exploration method may be utilized. More specifically, the device is used to scan a text by a method similar to discussed with references to FIGS. 1-3. Moreover, the user selects the information that needs further explanation by holding the text selected for 5 seconds. The text is highlighted, and a series of commands (e.g., definition, synonyms/antonyms, translation, related resources) are provided to the user for selection. The user selects a desired command, and the device displays the information on the display screen for the user. Various user interface options may be used to support the interaction between the user and the commands displays on the display screen. For example, audio option may be provided for the user to hear pronunciation of a specific word in the text. The user may choose to initiate the audio by tapping on the sound icon. The user may choose to change the language that the word is displayed in. The user may select a specific resource (e.g., book 1, book 2, book 3, article online, journal) under the resource command, which allows the user to search for more information related to the selected word. In another implementation, the device may recognize and analyze the content of the scanned content, search various databases for related publications and provide further guidance based on historical user pattern around the content. Moreover, the user may choose to save the list of resources to an external hardware, e-email, cloud services and/or alike, or the user may choose to share list of resources with others.

In another implementation, a citation mechanism may be utilized. First, the user of the device may select a citation style (e.g., APA, MLA Chicago/Turubian). It should be noted that the user is allowed to make changes in the citation style if desired. In one implementation, the selected citation style may be saved in a database under a user profile. Accordingly, when the user is logged into the device, the device knows what the preferred citation style for that user is. Then, the user selects a section of a surface for scanning. Once the section is selected, the device identifies text in that section. In one example, the user may select the section of the surface by scrolling over the text by a finger. Once the user removes the finger from the text, the device starts a document allowing the user to save the text and initiate the citation mechanism. The mechanism is linked to some electronic packages (e.g., EasyBib, KnightCite, Endnote, and Google) and plagiarism software that are activated when the user saves the text. The packages and software provide an updated version of the text, wherein the text includes the citation style selected by the user. Further, the user is allowed to share the citation through various platforms such as social media and e-mail.

Turning now to the operation of the device 100, FIG. 5 depicts a process flow diagram 500 in accordance with an example implementation. It should be readily apparent that the processes depicted in FIG. 5 represent generalized illustrations, and that other processes may be added or the illustrated processes may be removed, modified, or rearranged in many ways. Further, it should be understood that the processes may represent executable instructions stored on memory that may cause a processing device to respond, to perform actions, to change states, and/or to make decisions, for instance. Thus, the described processes may be implemented as executable instructions and/or operations provided by a memory associated with the device 100.

The illustrated process 500 begins at block 505, where a device comprising a transparent display and a scanner receives a selection of an area on a surface which is seen through the transparent display by adjusting a position of at least one camera on the scanner. Further, the device may visually indicate the area on the transparent display. For example, the area may be highlighted or captured in a box. At block 510, the device controls the scanner to scan the surface by adjusting position of the scanner based on the selection of the area. More specifically, the device scans only the area that is identified in the selection. Such selection can be entered by a user of the system. The user may hoover or roll his finger on the area that is desired to be selected. At block 515, the device provides information corresponding to the scanned area and displays such information on the transparent display. For example, the device may allow the user to further manipulate the scanned area. More specifically, the user may choose to share content of the scanned area via a suitable platform (e.g., email, social media) or print or translate such content. In addition, augmented reality technology may be utilized to overlay data on the scanned area.

While the above disclosure has been shown and described with reference to the foregoing examples, it should be understood that other forms, details, and implementations may be made without departing from the spirit and scope of the disclosure that is defined in the following claims.

What is claimed is:

1. A mobile system, comprising:
a transparent display screen;
a scanner head to scan a region seen through the transparent display, a position of the scanner being adjustable with respect to the transparent display, wherein the scanner comprises at least one camera and at least one light source;
an outer frame;
a cover to house the scanner head along with electronic components,
wherein the scanner head glides within the outer frame when scanning the region.

2. The system of claim 1, wherein the electronic components comprise a processor, a memory, a speaker, a power source and at least one connector.

3. The system of claim 2, wherein the power source is a battery.

4. The system of claim 2, wherein the power source is charged by a base when the system is docked into the base.

5. The system of claim 4, wherein the system is docked into the base via a magnetic strip.

6. The system of claim 4, wherein the base comprises a plurality of magnetic strips, and the base is used to charge and dock a plurality of mobile systems.

7. The system of claim 2, wherein the processor instructs:
an operation engine to manage the display screen;
a connection engine to establish connection between the display screen and the scanner; and
an application engine to manage command entries from a user to interact with system.

8. The system of claim 1, wherein the display screen is foldable and scrollable.

9. The system of claim 1, wherein the system is connected to other systems via USB, VGA, HDMI, Bluetooth or Wi-Fi.

10. The display system of claim 1, wherein the display screen has a curved shape to provide privacy to a user of the display screen and protect the security of the content displayed on each division of the display screen.

11. A processor-implemented method, comprising:
receiving, by a processor, a selection of an area of a surface, the surface comprising text;
instructing, by the processor, a scanner to scan the text in the selected area of the surface; and
overlaying, by the processor, data on the text over the selected area.

12. The method of claim 11, further comprising allowing a user to select a command associated with the scanned text, the command comprising a search on the text through a plurality of resources, a translation of the text, a definition of a word in the text, an identification of synonyms, and/or alike.

13. The method of claim 11, further comprising applying a citation mechanism to present the scanned text in a citation style, wherein the citation style is selected by a user.

14. The method of claim 11, wherein receiving the selection of the area of the surface comprises receiving a touch gesture from a user on a display screen, the touch gesture targeting specific areas of the display screen.

15. A non-transitory computer-readable medium comprising instructions which, when executed, cause a system with a transparent display and a scanner to:
receive a selection of an area of a surface, the surface comprising text;
instruct the scanner to scan the text in the selected area of the surface; and
overlay data over the selected area on the transparent display.
